(19) United States
(12) Patent Application Publication
(10) Pub. No.: US 2025/0340745 A1
(43) Pub. Date: Nov. 6, 2025

(54) A Composition and a Composite Material

(71) Applicant: National University of Singapore, Singapore (SG)

(72) Inventors: Rui-Qi PNG, Singapore (SG); Lay-Lay CHUA, Singapore (SG); Peter Kian-Hoon HO, Singapore (SG); Weiyong Desmond TEO, Singapore (SG); Aik Kieat TAN, Singapore (SG)

(21) Appl. No.: 18/866,448

(22) PCT Filed: May 17, 2023
(86) PCT No.: PCT/SG2023/050338

§ 371 Date: Nov. 15, 2024

(30) Foreign Application Priority Data
May 17, 2022 (SG) 10202205139Y

(51) Int. Cl. C09D 7/20; C08K 7/00; C08K 7/18; C08K 9/08; C09D 5/18; C09D 5/24; C09D 7/40; C09D 7/62; C09K 5/14

(52) U.S. Cl. CPC C09D 7/20; C09D 5/18; C09D 5/24; C09D 7/62; C09D 7/70; C09K 5/14; C08K 7/00; C08K 7/18; C08K 9/08; C08K 2201/001

(57) ABSTRACT

There is provided a composition comprising a deoxidizer solvent, a co-solvent and a plurality of silver particles suspended in a mixture of the deoxidizer solvent and the co-solvent, wherein the deoxidizer solvent comprises one or more compounds of the formula CₙOₘH₂ₙ₊₂₋ₚ(OH)ₚ, where n, m and p are integers, with the proviso that 1≤(n+m)/p≤8, and wherein the mixture of the deoxidizer solvent and the co-solvent comprises hydroxyl groups at a concentration in the range of 2 M to 20 M. There is also provided a method of forming the composition. There are also provided a method of forming a composition material and a device comprising N the composite material.

### REFERENCES TO RELATED APPLICATION

This application claims priority to Singapore application number 10202205139Y filed with the Intellectual Property Office of Singapore on 17 May 2022, the contents of which are hereby incorporated by reference.

### TECHNICAL FIELD

The present invention generally relates to a composition comprising a deoxidizer solvent, a co-solvent and a plurality of silver particles suspended in a mixture of the deoxidizer solvent and the co-solvent. The present invention also relates to a method of forming the composition. The present invention further relates to a method of forming a composite material from the composition and a device comprising the composite material.

### BACKGROUND ART

High performance electrical and thermal conductive materials are required as thermal interface, die attach, electrical interconnect and electrode materials to meet the challenges of next-generation devices, particularly high power and high speed electronics related to 5G. Thermal interface materials provide for thermal contact of the semiconductor chip with its heat sink, while die attach materials bond the chip to its substrate or package, often providing also for electrical and/or thermal contact. Electrical interconnect and electrode materials provide for contacts, bus bars, antennae and wirings, such as in solar cells, switches, capacitors, sensors, and other components of printed electronics.

Conventionally, silver (Ag) sinter materials based on powders have attracted considerable attention because of their potential for high electrical conductivity (6.2×10⁵ S/cm) and thermal conductivity (430 W/mK), and their high melting temperature (961° C.), which together deliver high performance with high temperature tolerance. They have demonstrated excellent manufacturing and operational reliability. Silver sinter materials can be formulated into pastes suitable for high-volume, low-cost deposition methods including syringe dispensing, screen and gravure printing, flexography, or other printing techniques. Furthermore, they are environmentally ‘green’, free from hazardous substances such as mercury, cadmium and lead. Copper is a possible alternative to silver, but many challenges remain for copper, especially the harsh conditions required for sintering and attendant tendency of oxidation.

Despite the advantages and widespread deployment of silver sinter pastes, several general challenges remain. The silver powder, employed primarily in the form of flakes, generally require a sintering temperature well above 250° C. for a long duration, and with the application of high pressure (more than 5 MPa) to reach electrical and thermal conductivities larger than 1.0×10⁵ S/cm and 75 W/mK, respectively. Although conventionally called “low-temperature sintering”, the required temperature and time are undesirable in future thermal management and electrical interconnect technologies.

In addition, sintering requires the formation of local silver bridges between adjacent silver particulates in the powder at a temperature well below its melting point. This process is not fully understood except that it is conditional on the decomposition or reduction of the native Ag₂O on the surfaces of the silver particulates to silver. The Ellingham diagram shows that Ag₂O is thermodynamically unstable particularly due to decomposition of silver above 147° C., but its activation energy is high. The deoxidation reaction of Ag₂O proceeds at an appreciable rate in air or nitrogen only above 300° C. However, it occurs at much lower temperatures, less than 200° C., in a reducing atmosphere of carbon monoxide, hydrogen, or ethylene. However, such reducing atmospheres bring their own challenges, which may not be desirable in the manufacture of electrical materials.

Further, pure sintered silver films generally adhere well to silver, gold, platinum and palladium layers, and substrates metallized with these layers, but not to others, such as semiconductors, oxides and plastics, without special pre-treatments. This presents a particular issue for thermal interface materials, as the total thermal resistance is the sum of bulk resistance through the thermal interface material, and the contact resistance at each of the two interfaces. To minimize thermal resistance, not only the thermal conductivity of the interface material needs to be high, but the thermal conductances at both its interfaces also need to be good. This generally requires a good adhesion to both the surface of the die and of the substrate or heat sink.

To improve adhesion, another conventional sinter material includes thermosetting resins such as acrylate, epoxy, polyimide, polyurethane or polysiloxane, in a formulation to provide a polymeric matrix. The resin may be prepolymerized, or polymerizable in reactive single-pot or two-pot formulations. This conventional material is known in the art as electrically conductive adhesives (ECAs), but electrical and thermal conductivities remain limited.

Particularly, the above conventional material generally provides good adhesion to many surfaces (better than 3 MPa lap shear strength), but at the expense of a lower bulk electrical and thermal conductivities of less than 7×10⁴ S/cm and 50 W/mK, respectively, even after sintering at 200° C. or higher.

Additionally, several main classes of silver sinter pastes are also known conventionally, each with its own advantages and limitations. For example, micron-silver pastes are based on micron-sized silver flakes with diameters between 0.2 and 20 μm, produced by ball milling and thus coated with the milling aid, such as oleic or stearic acid. For a good performance, they usually require a sintering temperature of 200° C. or higher, typically at 250 to 300° C., and a sintering pressure of 0.5 MPa or higher, typically at 2 to 5 MPa. These conventional materials have the longest history of development and proven to be reliable on record.

Numerous improvements to paste formulation to reduce sintering temperatures and improve adhesion are known conventionally. For example, Ag (I) compounds with low-decomposition temperatures, such as oxide, formate and carbonate, and oxidizing agents, may be added to lower the required sintering temperature when these compounds decompose to silver and bridge between the filler powders below their usual sintering temperature. Oxidizers, such as organic and inorganic peroxides, may also be added to promote oxidative degradation and volatilization of the organic coating on the silver powder. This also helps to lower the sintering temperature, but this poses a risk to the substrate and die reliability. Acidic fluxing agents and reducing agents may also be added to remove the oxide layer on metallized surfaces, such as copper, thereby promoting their adhesion to the sintered silver. Nevertheless, the pastes typically still have electrical and thermal conductivities of less than 1.0×10⁵ S/cm and less than 75 W/mK, respectively, when sintered at temperatures of 200° C. or lower, and pressures of 2 MPa or lower, in an inert atmosphere. Pressure sintering at a temperature of about 230 to 250° C. and a pressure of above 3 MPa is usually required to reach higher conductivities.

Nano-silver pastes are also known conventionally, which are usually based on nano-sized silver crystals suspended in a polymer binder. The Ag filler is produced by chemical reduction of Ag (I) salts in the presence of capping ligands or agents, such as methyloctylamine, dodecylamine, hexadecylamine, myristyl alcohol, 1-dodecanol, 1-decanol, stearic acid, oleic acid, palmitic acid, or dodecanethiol. The capping ligands or agents are required to stabilize the silver nanocrystals. The high volume fraction of capping agent required (usually more than 65 volume % of total solid) typically delays sintering till above 250° C. Polymer binders include poly(diallydimethyl ammonium chloride), polyvinyl pyrrolidone, polyacrylic acid, polystyrene sulfonate, polyvinyl alcohol, polyvinyl butyral, and ethyl cellulose. For the case of nano-silver particles with short ligands in sparse and sub-monolayer coverage, the sintering temperature required to reach an electrical conductivity of 1.0×10⁵ S/cm could be decreased to 150° C. without applying pressure. This demonstrates that shell volatilization, not surface melting as previously thought, determines the sintering temperature of nanocrystals, which could thus be controlled by ligand selection. Nevertheless, nano-silver pastes require chemical synthesis of the nano-silver, which is much more costly and laborious than production of silver powders by milling. In addition, the environmental and health effects of nanomaterials remain under discussion.

Hybrid-silver pastes are also conventionally known. These pastes combine micron-sized and nano-size silver particulates to obtain a higher fill density. Usually, bimodal formulations have a diameter ratio of about 3:x (where x≤1) and corresponding weight ratio of about 2:1. Trimodal formulations have a diameter ratio of about 10:3:x, with weight ratio of the large fraction to the combined smaller fractions being also of about 2:1. A higher densification and shear strength can be achieved in the hybrid-silver paster than micron-Ag or nano-Ag alone. However, to achieve desirable characteristics, the sintering temperature for the hybrid-silver paste must be higher than 300° C., and the sintering pressure must be larger than 2 MPa.

Accordingly, there is a need for a composition and a composite material that ameliorate one or more disadvantages mentioned above.

### SUMMARY

In one aspect, there is provided a composition comprising a deoxidizer solvent, a co-solvent and a plurality of silver particles suspended in a mixture of the deoxidizer solvent and the co-solvent,
wherein the deoxidizer solvent comprises one or more compounds of the formula CₙOₘH₂ₙ₊₂₋ₚ(OH)ₚ, where n, m and p are integers, with the proviso that 1≤(n+m)/p≤8, and
wherein the mixture of the deoxidizer solvent and the co-solvent comprises hydroxyl groups at a concentration in the range of 2 M to 20 M.

In another aspect, there is provided a method of forming a composition comprising the step of dispersing a plurality of silver particles in a deoxidizer solvent in the presence of a co-solvent or in a mixture of the deoxidizer solvent and the co-solvent.

In another aspect, there is provided a method of forming a composite material, comprising the step of sintering the composition as described herein on a substrate.

Advantageously, the composition does not require air or oxygen to “burn off” excess organics during the sintering step. Therefore, the composition is compatible with Cu and Al interconnects that may be present on a die. This is because any organic polymer used is present only in a small amount at the surface of the silver particles.

Further advantageously, the sintering of the composition does not require a cumbersome reducing atmosphere. This is because the deoxidizer solvent and the co-solvent provide for the chemical agent required for reduction of the silver oxide.

Still further advantageously, the sintering of the composition does not require a high pressure. Therefore, the present method does not require expensive pressure transducing equipment. This improves reliability of the die or substrate that is attached with the composite material. This advantage derives from the more efficient sintering achieved by the present method.

In one example, the sintering temperature is less than 200° C.

Advantageously, the composition may have an increased extent of decomposition or reduction of a native silver oxide where the sintering temperature is less than 200° C. In another aspect, there is provided a device comprising the composite material formed by the method as described herein.

### Definitions

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

The term “about” as used herein typically means+/−10% of the stated value, or 1 unit in the last digit of the stated value, whichever is larger.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a composition will now be disclosed.

The composition comprises a deoxidizer solvent, a co-solvent and a plurality of silver particles suspended in a mixture of the deoxidizer solvent and the co-solvent, wherein the deoxidizer solvent comprises one or more compounds of the formula CₙOₘH₂ₙ₊₂₋ₚ(OH)ₚ, where n, m and p are integers, with the proviso that 1≤(n+m)/p≤8, and
wherein the mixture of the deoxidizer solvent and the co-solvent comprises hydroxyl groups at a concentration in the range of 2 M to 20 M.

Advantageously, the composition may be made into a composite material having an electrical conductivity of at least about 1.0×10⁵ S/cm and a thermal conductivity of at least about 75 W/mK via sintering at a temperature of 200° C. or lower.

The deoxidizer solvent and the co-solvent may have a combined weight percentage in the range of about 6 weight % to about 30 weight %, about 12 weight % to about 25 weight % or about 18 weight % to about 25 weight %, based on the total weight of the composition.

The deoxidizer solvent and the co-solvent may have a volume ratio in the range of about 1:1.0 to about 1:10, or about 1:1.0 to about 1:5.

Advantageously, the deoxidizer solvent may avoid formation of gas bubbles during sintering of the composition when present in a diluted form.

The plurality of silver particles may have an average diameter in the range of about 0.2 μm to about 20 μm, about 5 μm to about 20 μm, about 10 μm to about 20 μm, about 15 μm to about 20 μm, about 0.2 μm to about 15 μm, about 0.2 μm to about 10 μm or about 0.2 μm to about 5 μm.

The plurality of silver particles may have a size distribution (i.e., a spread from 16% to 84% of a cumulative distribution by mass) in the range of about ±10% (i.e., a narrow dispersion) to about ±70% (i.e., a broad dispersion), ±20% to about ±70%, about ±50% to about ±70%, about ±10% to about ±50% or about ±10% to about ±20%, of the average diameter, as measured by particle size analysis (e.g., laser light scattering).

The size distribution may be a monomodal distribution, a bimodal distribution or a multimodal distribution.

Where the size distribution is a bimodal distribution, the size distribution may have a size ratio in the range of about 10:3 to about 10:0.3, about 10:1.0 to about 10:0.3 or about 10:3 to about 10:1.0.

Where the size distribution is a multimodal distribution, the size distribution may have a size ratio of about 10:3:1.0.

Advantageously, the size distribution as described above makes the plurality of silver particles particularly suitable for the present composition, as the plurality of silver particles comprise both smaller particles and bigger particles, where the smaller particles can fill voids between the bigger particles.

The plurality of silver particles may be in the form of flakes, granules, spheroids, or a combination thereof.

The plurality of silver particles may be in the form of flakes. Advantageously, the form of flakes may provide the composite material made from the composition a lower final porosity, a better conductivity and adhesion properties as compared with other forms.

Where the plurality of silver particles are in the form of flakes, the plurality of silver particles may have a specific surface area (i.e., an exposed surface area per unit mass) in the range of about 0.6 m²/g to about 2.5 m²/g, about 1 m²/g to about 2.5 m²/g, about 2 m²/g to about 2.5 m²/g, about 0.6 m²/g to about 2 m²/g or about 0.6 m²/g to about 1.0 m²/g. The specific surface area may be measured as a BET surface area by gas adsorption. Therefore, the specific area may be decided by how the plurality of silver particles have been prepared (e.g., via a milling process).

Where the plurality of silver particles are in the form of spheroids and have an average diameter of about 2 μm, the plurality of silver particles may have a specific surface area of about 0.3 m²/g.

The plurality of silver particles may have an increasing stiffness as the specific surface area decreases.

The plurality of silver particles may have a tapped density (i.e., a ratio between a total mass of the plurality of silver particles and a total volume occupied by the plurality of silver particles, after tapping the plurality of silver particles to a constant volume) of at least about 2.5 g/cm³ or at least about 3.5 g/cm³, as measured by a tap volumeter.

The plurality of silver particles may comprise elemental silver particles, silver alloy particles, silver-coated particles, silver oxide particles or a combination thereof.

The silver-coated particles may be silver-coated copper particles.

The composition may additionally comprise silver additives. Non-limiting examples of the silver additives include silver-coated silicon dioxide, silver-coated silicon carbide, silver-coated boron nitride, silver coated ceramic oxide, silver-coated glass, silver oxide, or a combination thereof. Advantageously, the presence of the silver additives may provide the composite material made from the composition a higher mechanical strength.

As described above, (n+m)/p denotes a hydroxyl number. A deoxidizer solvent having a smaller hydroxyl number (e.g., about 1 to about 2) has a high concentration of hydroxyl groups, thus the deoxidizer solvent may be used in a small amount (by mass) to achieve a deoxidation effect. However, such deoxidizer solvent also tends to give a vigorous reaction that produces gas bubbles during a deoxidation, which is undesirable as the gas bubbles expand the composite material during sintering. The composite material made from the composition may have lower conductivities and mechanical strength due to the generation of the gas bubbles, thus it is necessary to dilute the deoxidizer solvent.

Where the deoxidizer solvent has a large hydroxyl number (e.g., about 5 to about 8), a large amount (by mass) of the deoxidizer solvent is required to achieve the deoxidation effect and the deoxidation may proceed more slowly and smoothly.

Advantageously, it is convenient and inexpensive to adjust the deoxidizer solvent to control the deoxidation of the composition, if needed.

The deoxidizer solvent may have a boiling point in the range of about 190° C. to about 350° C., about 250° C. to about 350° C., about 300° C. to about 350° C., about 190° C. to about 300° C. or about 190° C. to about 250° C.

Advantageously, where the deoxidizer solvent has a boiling point as described above, the deoxidizer solvent will have a sufficiently low vapor pressure to substantially remain with the composition during the deoxidation of the same. Particularly, the deoxidation of the composition occurs at a deoxidation temperature, which is the lowest temperature at which the plurality of silver particles can be reduced at an appreciable reduction rate. The deoxidation temperature may be estimated by numerous ways, such as reacting bulk silver oxide powder with a putative deoxidizer solvent under a low temperature ramping rate (e.g., 2° C. per minute).

Further advantageously, as the deoxidizer solvent is in a liquid form, it may be completely removed by drying (e.g., longer annealing, higher temperature annealing, annealing in vacuum conditions or a combination of the above), leaving no residue to cause undesirable corrosion or other failures of the composite material made from the composition. Therefore, the deoxidizer solvent works better than deoxidizers or reductants in a solid form that are not easily removed by a drying step.

If the deoxidizer solvent is substantially lost (e.g., by evaporation) before the deoxidation temperature is reached, the deoxidizer solvent would not be effective. As described above, the boiling point of the deoxidizer solvent provides a proxy for its vapor pressure at lower temperatures. The inventors have found that certain deoxidizer solvents have an appreciable rate of evaporation (e.g., at an order of about 2 microns per minute) at a temperature of about 100° C. below their boiling point.

Thus, for interconnect applications, where the rate of evaporation is not attenuated properly for desired printed or dispensed patterns of the composition because the deposited composition is exposed and not covered by another component, the boiling point of the deoxidizer solvent may be at least about 100° C. or about 150° C. higher than the deoxidation temperature.

Alternatively, for thermal interface, die attach and other joining applications, the deoxidizer solvent may evaporate only along edges (e.g., of the die), and the rate of evaporation would depend on a size of the die. Thus, the boiling point of the deoxidizer solvent may be lower for these applications, e.g., about 50° C. higher than the deoxidation temperature. If the composition will be subject to a pre-drying treatment, the pre-drying treatment may have a temperature that is at least about 100° C. or about 150° C. lower than the boiling point of the deoxidizer solvent.

The deoxidizer solvent may be present at an amount that is computed from reaction stoichiometry. According to the following equation, a theoretical specific amount of hydroxyl groups required per unit mass of the plurality of silver particles (N) may be derived from the specific surface area of the plurality of silver particles (S), a thickness of the plurality of silver particles (d), a density of the plurality of silver particles (φ, a formula weight of the plurality of silver particles (M), and a stoichiometry number of the plurality of silver particles (ξ):

$$N = S \times d \times ρ / ( M \times ξ )$$

The plurality of silver particles may have a thickness (d) of 2×10⁻⁹ m, a density (φ of 7.14×10⁶ g/m³, a formula weight (M) of 231.7 g/mol, and a stoichiometry number (ξ) of 1, assuming each hydroxyl group acts as a two-electron reductant (i.e., reducing one formula unit of Ag₂O to Ag). In practice, a primary hydroxyl group may act as a four-electron reductant, which would change the stoichiometry number (ξ) to 2.

Therefore, where the plurality of silver particles are silver flakes having a specific surface area (S) in the range of about 0.6 m²/g to about 2.5 m²/g, the theoretical specific amount of hydroxyl groups (N) as calculated from the equation above is about 35 μmol/g to about 150 μmol/g. The inventors have found that the theoretical specific amount of hydroxyl groups (N) is sufficient to complete the deoxidation. Alternatively, the deoxidizer solvent may be present at an amount that is up to four-fold of the theoretical amount so as to compensate for losses (e.g., evaporation) of the deoxidizer solvent when processing the same.

Non-limiting examples of the deoxidizer solvent include ethylene glycol, diethylene glycol, triethylene glycol, tetraethylene glycol, dipropylene glycol, tripropylene glycol, isomers of propanediol, isomers of butanediol, isomers of pentanediol, isomers of hexanediol, isomers of heptanediol, isomers of octanediol, glycerol, pentaerythritol, dipentaerythritol, 2-(2-methoxyethoxy)ethanol, 2-(2-ethoxyethoxy)ethanol, and a combination thereof.

Surprisingly, deoxidizer solvents as described above are strong deoxidizers of bulk silver oxide powder Ag₂O at a low temperature (e.g., about 130° C.). Therefore, the deoxidizer solvent can advantageously promote sintering of the composition as deoxidizers.

Further advantageously, the deoxidizer solvent may avoid formation of gas bubbles during sintering of the composition when present in a diluted form to limit the vigor of the deoxidation reactions.

The deoxidizer solvent and the co-solvent are miscible with each other to form a homogeneous mixture when combined.

The co-solvent may have a boiling point in the range of about 60° C. to about 350° C., about 100° C. to about 350° C., about 200° C. to about 350° C., about 300° C. to about 350° C., about 60° C. to about 300° C., about 60° C. to about 200° C. or about 60° C. to about 100° C.

Advantageously, the co-solvent may determine a rheology of the composition in combination with the plurality of silver particles and the deoxidizer solvent. The co-solvent may additionally improve sintering characteristics of the composition. The co-solvent may further improve shelf lives, pot lives and work lives of the composition.

The co-solvent may have one or more of the following functions:

(i) A low boiling point co-solvent may improve the rheology of the composition as a diluent or a carrier solvent to give a desired concentration of the plurality of silver particles.

(ii) A high boiling-point co-solvent may improve a metal fill factor in the composite material made from the composition by diluting the deoxidizer solvent to an optimal concentration for a smooth deoxidation reaction.

(iii) A high boiling-point co-solvent may improve joints formed between the plurality of silver particles. The co-solvent may also improve joints formed between the composite material made from the composition and other surfaces. In this function, the co-solvent works as a sintering aid, wetting agent or a co-deoxidizer solvent at the deoxidation temperature set by the deoxidizer solvent, thereby improving conductivities and cohesion/adhesion strengths of the composite material made from the composition.

Where the co-solvent works as a carrier solvent which is intended to be evaporated away during the pre-drying treatment of the deoxidizer solvent, the boiling point of the co-solvent may be at least about 40° C. or 80° C. lower than the boiling point of the deoxidizer solvent. Advantageously, the lower boiling point of the co-solvent may improve a density of the composition during the pre-drying treatment before sintering of the composition. The improved density provides better performances for thermal interface and die attach applications, as well as a production of laminates on plastic carrier films from the composition.

The deoxidizer solvent, the co-solvent or mixture thereof may comprise hydroxyl groups at a concentration in the range of about 2 M to about 20 M, about 2 M to about 14 M, about 4 M to about 14 M, or about 6 M to 14 M. Both the deoxidizer solvent and the co-solvent may contribute to the overall hydroxyl group concentration as long as the final concentration of the hydroxyl groups falls within the above range. At the above concentration, the composition may be advantageously sintered smoothly. This concentration may reduce formation of gas bubbles, thus reducing an expansion of the composite material made from the composition.

Additionally or alternatively, where the co-solvent works as a co-deoxidizer solvent, the co-solvent may comprise polarizable groups such as alkenyl groups, aromatic groups, carbonyl groups, ether groups, and the like. Advantageously, the polarizable groups may help to transport Ag(I) ions and/or silver atoms from a local site of dissolution to a local site of deposition of silver, particularly in joints as described above (e.g., a neck region or a bridging region). Further, the co-solvent may induce a formation of silver mirrors on glass surfaces from Ag₂O powders at mild temperatures (e.g., about 130° C.) without substantially reducing the Ag₂O powders. Therefore, the co-solvent may act as a co-deoxidizer solvent by facilitating a transport of metal atoms or ions across the co-solvent and thereby enhancing sintering of the composition. As the co-solvent may act as the co-deoxidizer solvent, the co-solvent may persist at the deoxidation temperature. Accordingly, here, the co-solvent may have a boiling point that is similar to or higher than the boiling point of the deoxidizer solvent as described above. For this purpose also, the co-solvent may act as wetting solvent for deoxidizer solvent.

Non-limiting examples of the co-solvent include xylene isomers, mesitylene, tetralin, terpinene, limonene, linalool, α-terpineol, geraniol, citronellol, diglyme, 1,2-dibutoxyethane, diethylene glycol butyl methyl ether, triethylene glycol dimethyl ether, diethylene glycol butyl ether, tripropylene glycol methyl ether, triethylene glycol ethyl ether, triethylene glycol butyl methyl ether, triethylene glycol butyl ether, propylene glycol methyl ether, sulfolane, 2-(2-butoxyethoxy)ethanol, phenoxyethanol, 2-(benzyloxy)ethanol, di(propylene glycol) methyl ether, 2-butoxyethanol acetate, ethylene glycol diacetate, propylene glycol methyl ether acetate, di(propylene glycol) methyl ether acetate, 2-(2-ethoxyethoxy)ethyl acetate, ethylene glycol monobutyl ether acetate, 2-ethoxyethyl acetate, ethylene glycol monoethyl ether acetate, 2-butoxyethyl acetate, ethanolamine, diethanolamine, Texanol™ ester alcohol, diethyl adipate, dimethyl succinate, methyl benzoate, N-methylpyrrolidone, 7-butyrolactone, diethyl carbonate, propylene carbonate, safrole, anethole, cyclohexanone, cyclohexanol, carvone, ethyl sorbate, pseudoionone, farnesene, 2,6-dimethyl-2,4,6,-octatriene, o-cresol, methyl salicylate and a combination thereof.

The co-solvent and the deoxidizer solvent may be selected to provide the composition with a viscosity in the range of about 500 cP to about 500,000 cP, about 5,000 cP to about 50,000 cP, about 50,000 cP to 500,000 cP or about 500 cP to about 5,000 cP to have a desirable rheology. The viscosity may be measured at about 5 revolutions per minute.

The co-solvent and the deoxidizer solvent may be selected to provide the composition with a thixotropic index in the range of about 3 to about 8, about 5 to about 8 or about 3 to about 5 to have a desirable rheology. The thixotropic index may be measured at a ratio of about 0.5 to about 5 revolutions per minute.

The composition may further comprise a modifier polymer.

Polymers are typically used as binders to fill voids between metal particles and to improve an adhesion between metal particles and a substrate. The typical polymers are macromolecules having a molecular weight exceeding about 1 kDa and more than ten repeating units that are bonded together. The polymers are typically included in a composition at a volume ratio in the range of about 20:100 to about 50:100 relative to the metal particles. However, typical polymers severely impede sintering of the metal particles and limit electrical and thermal conductivities of the metal particles after sintering.

Unexpectedly, certain classes of polymers may be advantageously used as a modifier polymer that forms a molecularly-thin coating on a surface of the plurality of silver particles. The coating may have a thickness in the range of about 3.5 nm to about 9 nm, about 5.5 nm to about 9 nm, about 7 nm to about 9 nm, about 3.5 nm to about 7 nm or about 3.5 nm to about 5.5 nm.

The modifier polymer may have one or more of the following functions:

(i) The modifier polymer may improve the rheology and dispersibility of the composition by preventing aggregation of the plurality of silver particles.

(ii) The modifier polymer may improve an adhesion between the plurality of silver particles and unmetallized surfaces (e.g., surfaces of a semiconductor, an oxide or a plastic substrate).

(iii) The modifier polymer may improve sintering of the composition as a sintering aid, by lowering a sintering temperature required to sinter the composition and improving conductivities of the composite material made from the composition.

The modifier polymer may comprise hydrogen-bonding groups, polarizable groups, acidic groups, basic groups, other polar groups or a combination thereof. The modifier polymer may comprise ethylene glycol ether (—CH₂CH₂O—), acetal (—OCRR′O—), amine (—R″NH₂, —R″N(H)R′″—, —R″N(R)R′″—), pendant amide (—C(═O)NH—, —C(═O)N(R)—), urea (—NH(C═O)NH—), hydroxyl (—OH), carboxylic acid (—COOH), carboxylate (—COO⁻ M⁺), sulfonic acid (—SO₃H), sulfonate (—SO₃⁻ M⁺), phosphonic acid (—PO₃H₂), phosphonate (—PO₃H⁻ M⁺), alkene (—C(R)═C(R′)—), aromatic groups, or a combination thereof, wherein R, R′, R″ and R′″ are independently H or organic moieties. R and R′ may be methyl or ethyl. R″ and R′″ may be C₁-C₆ alkylene or C6-C10 arylene (e.g., phenylene or naphthylene).

The hydrogen-bonding groups, polarizable groups, acidic groups, basic groups and other polar groups may be independently present on a main chain, a block chain, a side chain or a graft chain on the modifier polymer. The modifier polymer may bind to a surface of Ag/Ag₂O or the unmetallized surfaces as described above.

Where the modifier polymer comprises ethylene glycol ether (—CH₂CH₂O—), acetal (—OCR′R″O—), amine (—R″NH₂, —R″N(H)R′″—, —R″N(R′)R′″—), pendant amide (—C(═O)NH—, —C(═O)N(R)—), urea (—NH(C═O)NH—), hydroxyl (—OH), alkene (—C(R)═C(R′)—), aromatic groups, or a combination thereof, wherein R, R′ and R″ are independently H or organic moieties, the modifier polymer may facilitate transport of metal atoms or ions over a surface of the plurality of metal particles, thereby accelerating a formation of joints (e.g., bridging contacts and neck regions) between adjacent silver particles and a coarsening of the neck regions.

The modifier polymer may be thermally stable when a device made from the composition is used. The modifier polymer may be thermally stable up to at least about 300° C., as determined by thermogravimetry analysis.

Non-limiting examples of the modifier polymer include poly(ethylene oxide), polyethyleneimine (both ethoxylated and non-ethoxylated), polyaniline, polypyrrole, poly(3,4-ethylenedioxythiophene), poly(lysine), poly(arginine), poly(histidine), poly(acrylic acid), poly(methacrylic acid), poly(aspartic acid), poly(glutamic acid), polyacrylamide, poly(vinylpyrrolidone), poly(acrylamido-2-methyl-1-propanesulfonic acid), poly(vinyl sulfonic acid), poly(styrenesulfonic acid), poly(vinyl phosphonic acid), poly(dopamine), dextran, carboxylmethyl cellulose, alginate, poly(serine), poly(2-hydroxyethylmethacrylate), poly(vinyl alcohol) (40-97% hydrolyzed), poly(vinyl butyral), and poly(hydroxystyrene), and their salts, if applicable; doped conducting polymers, including poly(ethylenedioxythiophene):poly(styrenesulfonic acid), poly(thiophene-3-[2-(2-methoxyethoxy)ethoxy]-2,5-diyl), and poly(triarylaminium-alt-fluorene) and their derivatives.

As the modifier polymer is not used as a binder like typical polymers, the modifier polymer may be present in a lower amount in the composition compared with typical polymers. For example, the modifier polymer may be present at a specific amount per unit mass of the plurality of silver particles (P), that is derived from the specific surface area of the plurality of silver particles (S), a nominal thickness of the modifier polymer (d), and a density of the modifier polymer (p) via the following equation:

$$P = S \times d \times ρ$$

The modifier polymer may have a density (p) of about 1.1×10⁶ g/m³. The modifier polymer may have a nominal thickness (d) in the range of about 3.5×10⁻⁹ m to about 9×10⁻⁹ m, about 6×10⁻⁹ m to about 9×10⁻⁹ m or about 3.5×10⁻⁹ m to about 6×10⁻⁹ m.

Thus, where the plurality of silver particles are silver flakes having a specific surface area (S) of about 1.6 m²/g, the modifier polymer and the plurality of silver particles may have a weight ratio in the range of about 0.6:100 to about 1.6:100, about 1.1:100 to about 1.6:100 or about 0.6:100 to about 1.1:100. The above weight ratio may correspond to a volume ratio between the modifier polymer and the plurality of silver particles in the range of about 6:100 to about 15:100, about 10:100 to about 15:100 or about 6:100 to about 10:100. Advantageously, the above weight ratio and volume ratio are significantly lower than those of typical polymers, as described above.

Where the plurality of silver particles are present at a weight percentage in the range of about 65 weight % to about 94 weight % based on the total weight of the composition, and have a specific surface area in the range of about 1.0 m²/g to about 2.2 m²/g, the modifier polymer may be present at a weight percentage in the range of about 0.3 weight % to about 1.9 weight % based on the total weight of the composition (or about 0.4 weight % to about 2 weight % based on the total weight of the plurality of silver particles). Where the plurality of silver particles are silver-coated particles (e.g., silver-coated copper particles), the modifier polymer may be present at a similar weight percentage as the silver-coated particles may have a density that is similar to the density of silver.

The composition may further comprise a reducing metal.

The reducing metal may comprise aluminium, magnesium, chromium, manganese, or a combination thereof.

The reducing metal may be present at a weight percentage of up to about 2.0 weight % or about 1.0 weight %, based on the total weight of the composition.

The reducing metal may have an average diameter that is similar to the average diameter of the plurality of silver particles.

Advantageously, the reducing metal may reduce native oxide on the silver particles and silver additives, and other metal oxides on the die or substrate to generate nascent hydrogen at low and safe concentrations by a reaction with the deoxidizer solvent and/or water at the sintering temperature. The hydrogen may be released and may reduce the remaining silver oxide and the other metal oxides on a surface of a substrate or a die.

Exemplary, non-limiting embodiments of a method of forming a composition will now be disclosed.

The method comprises the step of dispersing a plurality of silver particles in a deoxidizer solvent in the presence of a co-solvent or in a mixture of the deoxidizer solvent and the co-solvent.

The plurality of silver particles, the deoxidizer solvent and the co-solvent may be as described herein.

The method may further comprise a step of treating the plurality of silver particles with a modifier polymer.

Where the modifier polymer is substantially soluble in the deoxidizer solvent and/or the co-solvent, the treating step may be undertaken after the dispersing step. The treating step may comprise dissolving the modifier polymer in the composition and mixing the composition. Therefore, the method may comprise the steps of:
a) dispersing a plurality of silver particles in a deoxidizer solvent in the presence of a co-solvent to form a dispersion;
b) dissolving a modifier polymer in the dispersion; and
c) mixing the dispersion to form the composition.

The mixing step (c) may be undertaken by shear mixing or sonication. In the mixing step, the modifier polymer may exchange with a protective molecular monolayer or other processing aids on a surface of the plurality of silver particles spontaneously.

The exchange may further take place when the composition formed by the method is being sintered.

Alternatively, where the modifier polymer is not substantially soluble in the deoxidizer solvent and/or the co-solvent, the treating step may be undertaken before the dispersing step. The treating step may comprise dissolving and mixing the modifier polymer and the plurality of silver particles in an exchange solvent, and subsequently isolating the plurality of silver particles. Therefore, the method may comprise the steps of:
a) dissolving a plurality of silver particles and a modifier polymer in an exchange solvent to form a dispersion;
b) mixing the dispersion;
c) isolating the plurality of silver particles from the dispersion; and
d) dispersing a plurality of silver particles in a deoxidizer solvent in the presence of a co-solvent to form the composition.

In the dissolving step (a), the exchange solvent may have a good solubility for a protective molecular monolayer or other processing aids on a surface of the plurality of silver particles. The exchange solvent may have a relatively lower solubility for the modifier polymer. To determine whether the dissolving step has been successfully undertaken, the dispersion of step (a) may be characterised by surface analysis techniques, such as X-ray photoemission spectroscopy.

The mixing step (b) may be undertaken by shear mixing or sonication.

The mixing step (b) may be undertaken at a temperature in the range of about 20° C. to about 100° C., about 60° C. to about 100° C. or about 20° C. to about 60° C.

In the mixing step (b), the modifier polymer may exchange with a protective molecular monolayer or other processing aids on a surface of the plurality of silver particles spontaneously.

The isolating step (c) may be undertaken by filtration or centrifugation.

The isolating step (c) may further comprise rinsing the plurality of silver particles with a rinsing solvent to remove excess modifier polymer that has not been bound to the plurality of silver particles during the mixing step. The rinsing solvent may have a low boiling point to allow them to be removed easily. The rinsing solvent may be ethanol, isopropanol, or a combination thereof.

The isolating step (c) may further comprise drying the plurality of silver particles. The exchange solvent and the rinsing solvent (where present) may be removed from the plurality of silver particles by drying. Thereafter, the plurality of silver particles may be used in the dispersing step (d) to form the composition.

Where the plurality of silver particles have a specific surface area in the range of about 1.0 m²/g to about 2.2 m²/g, the plurality of silver particles may comprise silver particles at a weight percentage in the range of about 98 weight % to about 99.6 weight % and the modifier polymer at a weight percentage in the range of about 0.4 weight % to about 2 weight %, based on the total weight of the plurality of silver particles after the treating step.

The composition as described herein may be formed by the method as described herein.

Exemplary, non-limiting embodiments of a method of forming a composite material will now be disclosed.

The method comprises the step of sintering the composition as described herein on a substrate.

Advantageously, the composition does not require air or oxygen to “burn off” excess organics during the sintering step. Therefore, the composition is compatible with Cu and Al interconnects that may be present on a die. This is because any organic polymer used is present only in a small amount at the surface of the silver particles.

Further advantageously, the sintering of the composition does not require a cumbersome reducing atmosphere. This is because the deoxidizer solvent and the co-solvent provide for the chemical agent required for reduction of the silver oxide.

Still further advantageously, the sintering of the composition does not require a high pressure. Therefore, the present method does not require expensive pressure transducing equipment. This improves reliability of the die or substrate that is attached with the composite material. This advantage derives from the more efficient sintering achieved by the present method.

The sintering step may be undertaken at a temperature of about 200° C. or lower. The sintering step may be undertaken at a temperature in the range of about 140° C. to about 180° C., or about 150° C. to about 180° C. The temperature may be set and/or monitored by a digital hotplate or an oven.

Advantageously, the composition may have an increased extent of decomposition or reduction of a native silver oxide where the sintering temperature is less than 200° C.

The sintering step may be undertaken in an inert atmosphere. The sintering step may be undertaken in nitrogen.

Advantageously, the sintering step may convert the composition into dense and substantially fused agglomerated metal powders without microscopic voids or polymer phases.

The method may further comprise a step of pre-drying the composition before the sintering step.

The method may further comprise a step of contacting the composition with a second substrate or component before the sintering step.

The contacting step may be undertaken by depositing the composition onto the second substrate or component. The depositing of the composition may be undertaken using various printing and coating techniques, such as needle dispensing, blade coating, stencil, screen, gravure or flexo printing, and the like. Where the composition is deposited onto the substrate and the second substrate or component simultaneously, the method may comprise the steps of:
a) depositing the composition as described herein onto the substrate and the second substrate or component; and
b) sintering the composition.

Alternatively, the composition may be deposited onto the one or more substrates sequentially. Therefore, the method may comprise the steps of:
a) depositing the composition as described herein onto a substrate;
b) pre-drying the composition to form a laminate;
c) contacting the laminate with a second substrate or component; and
d) sintering the laminate.

The substrate may be a plastic film.

The pre-drying step (b) may be undertaken at a temperature that is lower than the temperature of the sintering step (d). The pre-drying step (where present) may be undertaken before the contacting step (where present).

The second substrate or component may be a device, a wafer, or a die.

Advantageously, the pre-drying step (b) may reduce processing time for the second substrate or component, provide a good control over a thickness of the laminate and allow for greater processing flexibility.

In the contacting step (c), the second substrate or component may be selected from the group consisting of electronic components and thermal components.

Therefore, the composite material may join the substrate an the second substrate or component after the sintering step. The composite material together with the substrate and the second substrate or component may be regarded as a device.

Therefore, the method may be regarded as a method of making a device for connecting vertical electronic or thermal components. In the device, the composite material may be sandwiched between a first electronic component and a second electronic or thermal component.

Alternatively or additionally, the method may be regarded as a method of making a device for connecting lateral electronic or thermal components, or for connecting different regions of an electronic or thermal component. In the device, the composite material may be formed in a lateral pattern to join the electronic or thermal components, or the different regions or an electronic or thermal component.

Advantageously, the composite material may be used as electrical and thermal conductive materials, such as thermal interface, die attach, electrical interconnect or electrode materials.

Where the composite material is used as a thermal interface material, it may provide for a thermal contact of a semiconductor chip with a heat sink.

Where the composite material is used as a die attach material, it may bond the chip to a substrate or a package, thereby also providing for an electrical and/or thermal contact.

Where the composite material is used as a thermal interface material or a die attach material, it may be fabricated to have a thickness in the range of about 10 μm to about 500 μm, about 50 μm to about 500 μm, about 200 μm to about 500 μm, about 10 μm to about 200 μm, about 10 μm to about 50 μm or about 50 μm to about 200 μm.

Where the composite material is used as an electrical interconnect material or an electrode material, it may provide for contacts, bus bars, antennae and wirings, such as in solar cells, switches, capacitors, sensors, and other components of printed electronics. The composite material may be fabricated to a thickness in the range of about 100 nm to about 10 μm, about 1.0 μm to about 10 μm or about 100 nm to about 1 μm.

Where the composite material is deposited onto a device or a substrate, the composite material may be fabricated to have a width in the range of about 10 μm to about 1.0 mm, about 100 μm to about 1.0 mm or about 10 μm to about 100 μm. The composite material may have a length in the range of about 10 μm to about 10 m, about 100 cm to about 10 m, about 1.0 m to about 10 m, about 10 cm to about 1.0 m or about 10 cm to about 100 cm.

Where the composite material is deposited over a heat generating device or a relevant substrate, it may be fabricated to have a length in the range of about 10 mm to about 1.0 cm, about 100 mm to about 1.0 cm or about 10 mm to about 100 mm. The composite material may be fabricated to have a width in the range of about 10 mm to about 1.0 cm, about 100 mm to about 1.0 cm or about 10 mm to about 100 mm.

The composite material may be used in the absence of the substrate. Therefore, the method may further comprise a step of removing the substrate.

Exemplary, non-limiting embodiments of a composite material will now be disclosed.

The composite material may be prepared by the method as described herein. Therefore, the composite material may comprise dense and substantially fused agglomerated metal powders without microscopic voids or polymer phases.

The composite material may be used for transporting electric current and/or heat current across connected electronic components.

Advantageously, the composite material may have an electrical conductivity of at least about 1.0×10⁵ S/cm and a thermal conductivity of at least about 75 W/mK.

Exemplary, non-limiting embodiments of a device will now be disclosed.

The device may be prepared by the method as described herein.

Therefore, the device may comprise the composite material formed by the method as described herein.

The device may be an electronic device.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1A is a scanning electron micrograph (SEM) of a cross-sectional area of an exemplary composite material made according to the present application. Scale bar of FIG. 1A is 10 μm.

FIG. 1B is a SEM of a cross-sectional area of an exemplary composite material made according to the present application. Scale bar of FIG. 1B is 10 μm.

FIG. 1C is a SEM of a cross-sectional area of an exemplary composite material made according to the present application. Scale bar of FIG. 1C is 10 μm.

FIG. 1D is a SEM of a cross-sectional area of an exemplary composite material made according to the present application. Scale bar of FIG. 1D is 10 μm.

FIG. 1E is a SEM of a cross-sectional area of an exemplary composite material made according to the present application. Scale bar of FIG. 1E is 10 μm.

FIG. 1F is a SEM of a cross-sectional area of an exemplary composite material made according to the present application. Scale bar of FIG. 1F is 10 μm.

### EXAMPLES

Non-limiting examples of the invention will be further described in greater detail by reference to specific Examples, which should not be construed as in any way limiting the scope of the invention. The actual performance depends on attributes of the particles, details of formulation, processing and method of application. In some cases, tapping and centrifugation are used to improve metal fill factor.

### Example 1—Preparation of Pastes with Silver Flakes and Modifier Polymer

The following examples show pastes with silver flakes and modifier polymer formulated by first dissolving the modifier polymer into a solvent system, followed by mixing with metal powder. Silver flakes and spheres as used herein are available from commercial sources, such as Heraeus, Hitachi, Henkel, Inframat Advanced Materials, ACS Material, Fukuda Metal Foil & Powder, Hongwu Material Tech, Tanaka Precious Metals, Johnson Matthey, DuPont, Technic, Doduco, Yamamoto Precious Metal, Mitsui Kinzoku, Ningbo Jingxin, Changgui Metal Powder, and American Elements.

### Example 1a

0.22 mL of poly(hydroxystyrene) (purchased from Sigma-Aldrich, Singapore) dissolved in a mixture of diglyme (purchased from Sigma-Aldrich, Singapore), glycerol (purchased from Sigma-Aldrich, Singapore) and ethylene glycol (purchased from Sigma-Aldrich, Singapore) (6.0:0.5:1.5 v/v) at a polymer concentration of 54 mg/mL was mixed with 1.0 g of silver flakes (manufacturer specifications: flake size=3 to 5 μm; tap density=2.8 to 3.8 g/cm³; and specific surface area=0.6 to 1.3 m²/g) on a vortex mixer and bath sonicator to give a paste with 81.7 weight % silver, 1.0 weight % polymer and solvent as the remainder. This formulation corresponded to silver at 29 volume % based on the total volume of the formulation. The formulation was applied by doctor blading onto native SiO₂/Si substrates to a wet thickness of 250 μm and area of 8×8 mm². The paste was pre-dried at 60° C. for 20 minutes in air, attached with a glass coated with fluoropolymer (purchased from Sigma-Aldrich, Singapore), then heated at a temperature ramping rate of 7.5° C. per minute to 160° C. with isothermal hold for 30 minutes, in nitrogen.

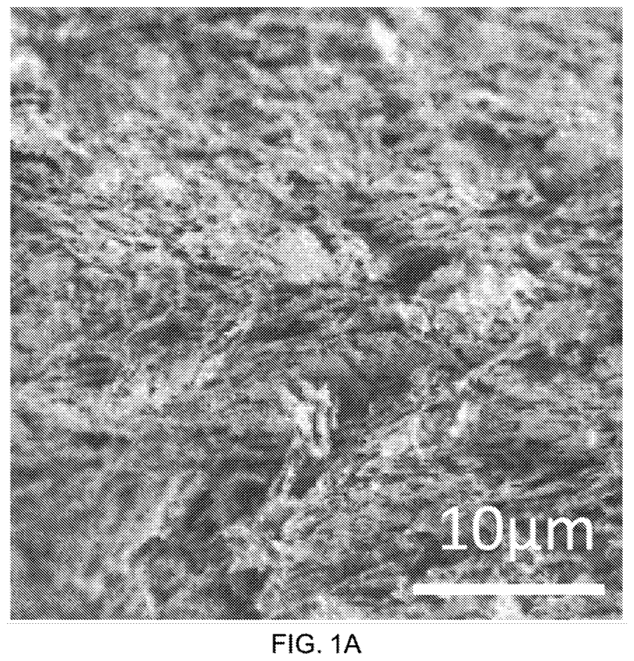

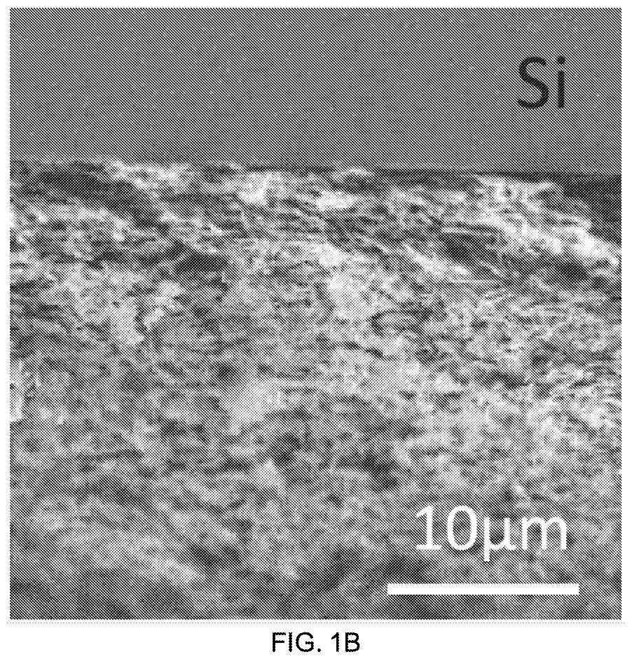

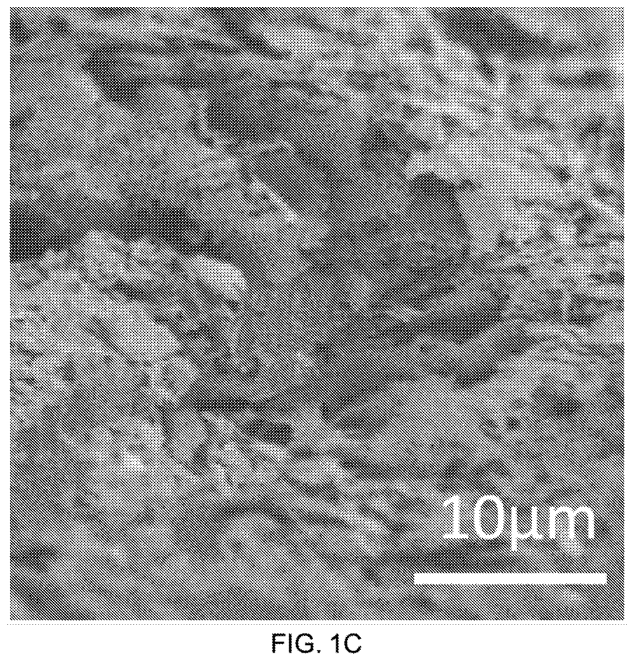

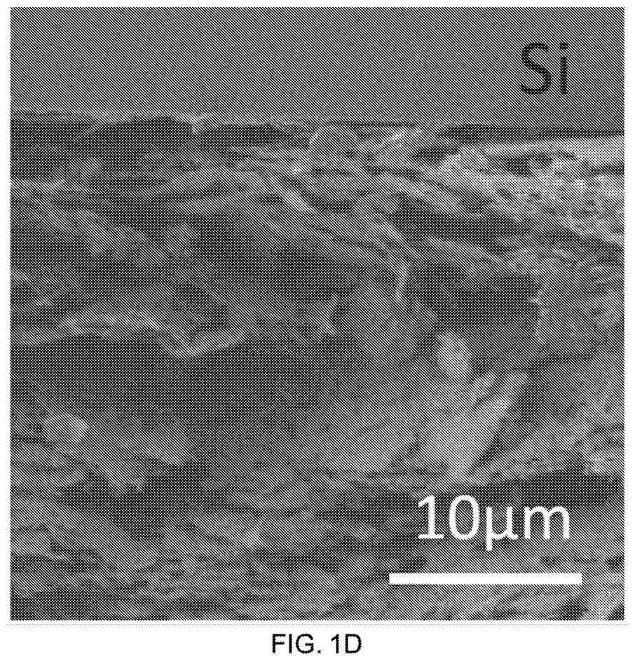

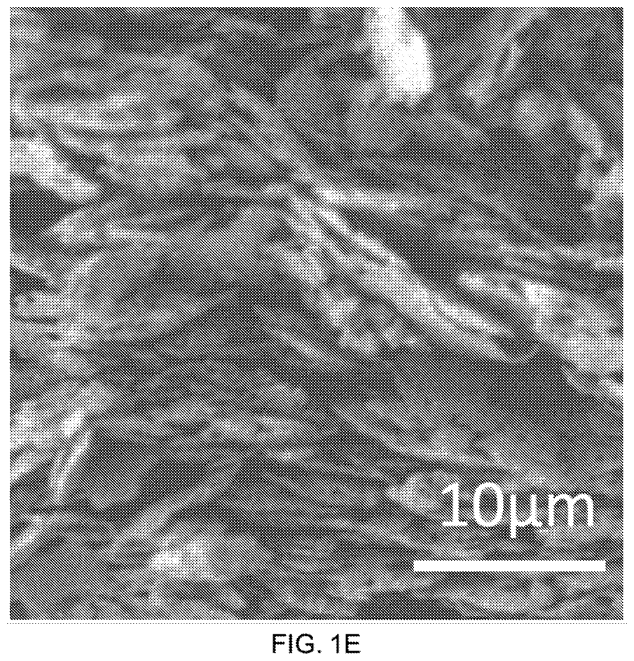

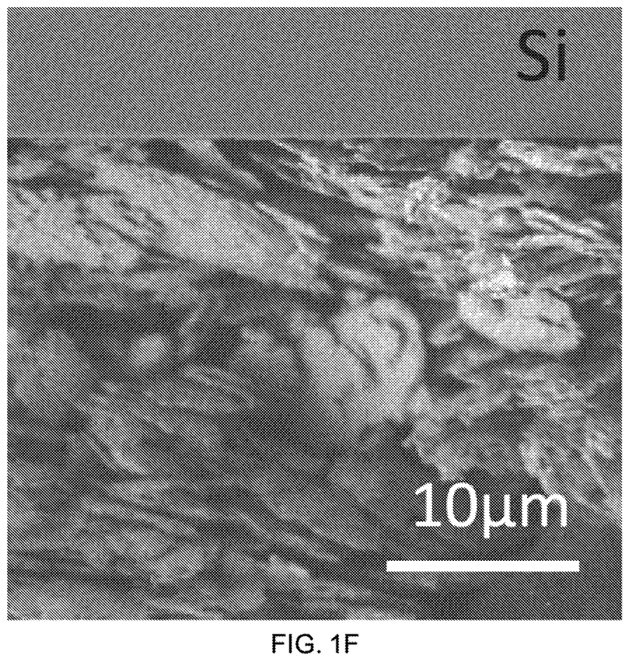

FIG. 1A is a SEM of a cross section in a bulk portion of a 130 μm-thick metal composite of silver flakes (having an average size of about 3 to 5 μm), with 1.0 weight % of poly(hydroxystyrene), as described in Example 1a. The metal composite was formulated with diglyme, glycerol and ethylene glycol at a volume ratio of 6.0:0.5:1.5 and was pressureless-sintered at 160° C. for 30 minutes in nitrogen.

FIG. 1B is a SEM of a cross section at an interface between the metal composite as shown in FIG. 1A and native SiO₂/Si.

### Example 1b

0.22 mL of 40%-hydrolyzed poly(vinyl alcohol) (purchased from Mitsubishi Chemical Corporation, Japan) dissolved in a mixture of α-terpineol (purchased from Sigma-Aldrich, Singapore) and triethylene glycol (purchased from Sigma-Aldrich, Singapore) (7:1 v/v) at a polymer concentration of 41 mg/mL was mixed with 1.0 g of silver flakes (manufacturer specifications: flake size, =5 to 8 μm; tap density=2.2 to 2.8 g/cm³; specific surface area, 0.6 to 1.2 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was partially enclosed by a cover slip, then heated at a single temperature ramping rate of 3° C. per minute to 200° C. with isothermal hold for 30 minutes, in nitrogen.

### Example 1c

0.22 mL of 40%-hydrolyzed poly(vinyl alcohol) dissolved in a mixture of diglyme, glycerol and ethylene glycol (6.0:0.5:1.5 v/v) at a polymer concentration of 41 mg/mL was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen. FIG. 1C is a SEM of a cross section in a bulk portion of a 120 μm-thick metal composite of silver flakes (average size of 5 to 8 μm), with 0.7 weight % of 40% hydrolyzed poly(vinyl alcohol), formulated with diglyme, glycerol and ethylene glycol (6.0:0.5:1.5 v/v) and pressureless sintered at 160° C. for 30 minutes in nitrogen, as described in Example 1c.

FIG. 1D is a SEM of a cross section at an interface between the metal composite as shown in FIG. 1C and native SiO₂/Si.

### Example 1d

0.22 mL of 40% hydrolyzed poly(vinyl alcohol) dissolved in a mixture of propylene glycol methyl ether acetate (purchased from Sigma-Aldrich, Singapore), diethylene glycol (purchased from Sigma-Aldrich, Singapore) and tetralin (purchased from Sigma-Aldrich, Singapore) (5:2:1 v/v) at a polymer concentration of 41 mg/mL was mixed with 1.0 g of silver flakes (manufacturer specifications: flake size=8 to 12 μm; tap density=3.5 to 4.2 g/cm³; specific surface area, 0.6 to 1.0 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen.

FIG. 1E is a SEM of a cross section in a bulk portion of a 110 μm-thick metal composite of silver flakes (average size of 8 to 12 μm), with 0.7 weight % of 40% hydrolyzed poly(vinyl alcohol), formulated with propylene glycol methyl ether acetate, diethylene glycol and tetralin (5:2:1 v/v) and pressureless sintered at 160° C. for 30 minutes in nitrogen, as described in Example 1d.

FIG. 1F is a SEM of a cross section at an interface between the metal composite as shown in FIG. 1E and native SiO₂/Si.

FIGS. 1A to 1F show that the metal composites tested comprised dense and substantially fused agglomerate of silver powders without microscopic voids or polymer phases, regardless of the size of the silver flakes, and did not have visible polymer “binder”. The micrographs at the SiO₂/Si interface reveal conformal and close packing of the silver flakes against that interface. In some cases, a sub-micron-thick silver film appeared to have been deposited over the SiO₂. This accounts for the unexpectedly advantageous adhesion with the substrate.

### Example 1e

0.22 mL of poly(hydroxystyrene) dissolved in a mixture of diglyme, glycerol and ethylene glycol (6.0:0.5:1.5 v/v) at a polymer concentration of 54 mg/mL was mixed with 1.0 g of silver flakes (manufacturer specifications: flake size=8 to 12 μm; tap density=3.5 to 4.2 g/cm³; specific surface area=0.6 to 1.0 m²/g) on a vortex mixer and bath sonicator to give a paste with 81.7 weight % silver, 1.0 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 15 minutes, in nitrogen.

### Example 1f

0.22 mL of poly(ethylene imine) (purchased from Sigma-Aldrich, Singapore) dissolved in a mixture of α-terpineol and triethylene glycol (7:1 v/v) at a polymer concentration of 27 mg/mL was mixed with 1.0 g of silver flakes (manufacturer specifications: flake size=8 to 10 μm; tap density=2.8 to 3.8 g/cm³; specific surface area=0.7 to 1.3 m²/g) on a vortex mixer and bath sonicator to give a paste with 82.1 weight % silver, 0.5 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was partially enclosed by a cover slip, then heated at a single temperature ramping rate of 3° C. per minute to 200° C. with isothermal hold for 30 minutes, in nitrogen.

### Example 1g

0.22 mL of 40% hydrolyzed poly(vinyl alcohol) dissolved in a mixture of α-terpineol and triethylene glycol (7:1 v/v) at a polymer concentration of 41 mg/mL was mixed with 1.0 g of silver flakes (manufacturer specifications: flake size=8 to 10 μm; tap density=2.8 to 3.8 g/cm³; specific surface area=0.7 to 1.3 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was partially enclosed by a cover slip, then heated at a single temperature ramping rate of 3° C. per minute to 200° C. with isothermal hold for 30 minutes, in nitrogen.

### Example 1h

0.22 mL of 40% hydrolyzed poly(vinyl alcohol) dissolved in a mixture of diglyme, glycerol and ethylene glycol (6.0:0.5:1.5 v/v) at a polymer concentration of 41 mg/mL was mixed with 1.0 g of silver flakes (manufacturer specifications: flake size=8 to 10 μm; tap density=2.8 to 3.8 g/cm³; specific surface area=0.7 to 1.3 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was partially enclosed by a cover slip, then heated at a single temperature ramping rate of 3° C. per minute to 200° C. with isothermal hold for 30 minutes, in nitrogen.

### Example 1i

0.22 mL of poly(vinylbutyral) (purchased from Sigma-Aldrich, Singapore) dissolved in a mixture of diglyme, glycerol and ethylene glycol (6.0:0.5:1.5 v/v) at a polymer concentration of 41 mg/mL was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen.

### Example 2—Preparation of Pastes with Silver Spheroids and Modifier Polymer

The following examples show pastes with silver spheroids and modifier polymer formulated by first dissolving the modifier polymer into a solvent system, followed by mixing with metal powder.

### Example 2a

0.21 mL of poly(ethylene imine) dissolved in a mixture of α-terpineol and glycerol (7.5:0.5 v/v) at a polymer concentration of 68 mg/mL was mixed with 1.2 g of silver spheroids (manufacturer specifications: diameter=6 μm; tap density=4.0 g/cm³) on a vortex mixer and bath sonicator to give a paste with 84.7 weight % silver, 1.0 weight % polymer, and solvent as the remainder. This formulation corresponded to silver at 34 volume % based on the total volume of the formulation. This formulation was applied by doctor blading onto native SiO₂/Si substrates to a wet thickness of 250 μm and area of 8×8 mm². The paste was partially enclosed by a cover slip, then heated at a single temperature ramping rate of 3° C. per minute to 200° C. with isothermal hold for 30 minutes, in nitrogen.

### Example 2b

0.11 mL of poly(ethylene imine) dissolved in a mixture of α-terpineol and glycerol (7:1 v/v) at a polymer concentration of 126 mg/mL was mixed with 1.2 g of silver spheroids (manufacturer specifications: diameter=6 μm; tap density=4.0 g/cm³) on a vortex mixer and bath sonicator to give a paste with 90.7 weight % silver, 1.1 weight % polymer, and solvent as the remainder. This formulation corresponded to silver at 47 volume % based on the total volume of the formulation. This formulation was applied by doctor blading onto native SiO₂/Si substrates to a wet thickness of 250 μm and area of 8×8 mm². The paste was partially enclosed by a cover slip, then heated at a single temperature ramping rate of 3° C. per minute to 200° C. with isothermal hold for 30 minutes, in nitrogen.

### Example 3—Preparation of Pastes Using Modifier Polymer-Coated Silver Flakes

The following examples show the preparation of silver flakes coated with modifier polymer, and pastes formulated by mixing the modifier polymer-coated silver flakes into a solvent system.

### Example 3a

1.2 mL of poly(vinyl pyrrolidone) (purchased from Sigma-Aldrich, Singapore) dissolved in ethylene glycol at a polymer concentration of 60 mg/mL was mixed with 3.0 g of silver flakes (manufacturer specifications: flake size=5 to 8 μm; tap density=2.2 to 2.8 g/cm³; specific surface area=0.6-1.2 m²/g) on a vortex mixer and bath sonicator, and left overnight. 12 mL of ethylene glycol was added and the silver flakes were isolated by centrifugation. The flakes were rinsed with 12 mL of Millipore® water, isolated by centrifugation, further rinsed with 12 mL of isopropanol (purchased from Sigma-Aldrich, Singapore), isolated by centrifugation, and finally vacuum-dried. 0.22 mL of a mixture of diglyme, glycerol and ethylene glycol (6.0:0.5:1.5 v/v) was mixed with 1.0 g of the polymer-coated silver flakes on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen.

### Example 3b

1.2 mL of poly(2-hydroxyethylmethacrylate) (purchased from Sigma-Aldrich, Singapore) dissolved in ethylene glycol at a polymer concentration of 60 mg/mL was mixed with 3.0 g of silver flakes (manufacturer specifications: flake size=5 to 8 μm; tap density=2.2 to 2.8 g/cm³; specific surface area=0.6 to 1.2 m²/g) on a vortex mixer and bath sonicator, and left overnight. 12 mL of ethylene glycol was added and the silver flakes were isolated by centrifugation. The flakes were rinsed with 12 mL of Millipore® water, isolated by centrifugation, further rinsed with 12 mL of isopropanol, isolated by centrifugation, and finally vacuum-dried. 0.22 mL of a mixture of diglyme, glycerol and ethylene glycol (6.0:0.5:1.5 v/v) was mixed with 1.0 g of the polymer-coated silver flakes on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen.

### Example 3c

1.2 mL of 80% hydrolyzed poly(vinyl alcohol) (purchased from Mitsubishi Chemical Corporation, Japan) dissolved in ethylene glycol at a polymer concentration of 60 mg/mL was mixed with 3.0 g of silver flakes (manufacturer specifications: flake size=5 to 8 μm; tap density=2.2 to 2.8 g/cm³; specific surface area=0.6 to 1.2 m²/g) on a vortex mixer and bath sonicator, and left overnight. 12 mL of ethylene glycol was added and the silver flakes were isolated by centrifugation. The flakes were rinsed with 12 mL of Millipore® water, isolated by centrifugation, further rinsed with 12 mL of isopropanol, isolated by centrifugation, and finally vacuum-dried. 0.22 mL of a mixture of propylene glycol methyl ether acetate (purchased from Sigma-Aldrich, Singapore), diethylene glycol and tetralin (5:2:1 v/v) was mixed with 1.0 g of the polymer-coated silver flakes on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen.

### Example 4—Preparation of a Paste Using Modifier Polymer-Coated Silver Flakes in Diglyme

The following example is a paste formulated by mixing a modifier polymer-coated silver flakes into diglyme.

### Example 4a

0.22 mL of diglyme was mixed with 1.0 g of poly(2-hydroxyethylmethacrylate)-coated silver flakes (as described in Example 3b) on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, then infused with 0.02 mL of a mixture of geraniol and diethylene glycol in a 1:1 volume ratio, attached with a fluoropolymer-coated glass, then heated at a temperature ramping rate of 7.5° C. per minute to 160° C. with isothermal hold for 30 minutes, in nitrogen.

### Example 5—Preparation of a Paste without Modifier Polymer

The following example is a paste formulated by mixing silver flakes into a solvent system. This example is useful as a thermal interface material or die-attach material for metallized surfaces, such as direct bonded copper, or contacts, respectively.

### Example 5a

0.22 mL of a mixture of α-terpineol and triethylene glycol (7:1 v/v) was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 100° C. for 20 minutes in air, attached with a fluoropolymer-coated glass, then heated at a temperature ramping rate of 7.5° C. per minute to 200° C. with isothermal hold for 30 minutes, in nitrogen.

### Example 5b

0.33 mL of a mixture of propylene glycol methyl ether acetate, geraniol (purchased from Sigma-Aldrich, Singapore) and diethylene glycol (2:4:4 v/v) was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 75.4 weight % silver, and solvent as the remainder. This formulation corresponded to silver at 23 volume % based on the total volume of the formulation. This formulation was dispensed onto native SiO₂/Si substrates. The paste was attached with a fluoropolymer-coated glass, then heated at a temperature ramping rate of 3° C. per minute from 60° C. to 160° C. with isothermal hold for 30 minutes, in nitrogen.

### Example 5c

0.33 mL of a mixture of propylene glycol methyl ether acetate, α-terpineol and diethylene glycol (2:4:4 v/v) was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 75.4 weight % silver, and solvent as the remainder. This formulation corresponded to silver at 23 volume % based on the total volume of the formulation. This formulation was dispensed onto native SiO₂/Si substrates. The paste was attached with a fluoropolymer-coated glass, then heated at a temperature ramping rate of 3° C. per minute from 60° C. to 160° C. with isothermal hold for 30 minutes, in nitrogen.

### Example 5d

0.33 mL of a mixture of propylene glycol methyl ether acetate, α-terpineol and diethylene glycol (2:4:4 v/v) was mixed with 1.0 g of silver flakes (manufacturer specifications: flake size=5 to 8 μm; tap density=2.2 to 2.8 g/cm³; specific surface area=0.6 to 1.2 m²/g) and 0.05 g of silver oxide (purchased from Sigma-Aldrich, Singapore) on a vortex mixer and bath sonicator to give a paste with 71.8 weight % silver, 3.8 weight % silver oxide (purchased from Sigma-Aldrich, Singapore), and solvent as the remainder. This formulation corresponded to silver at 23 volume % based on the total volume of the formulation. This formulation was dispensed onto native SiO₂/Si substrates. The paste was attached with a fluoropolymer-coated glass, then heated at a temperature ramping rate of 3° C. per minute from 60° C. to 160° C. with isothermal hold for 30 minutes, in nitrogen.

### Example 5e

0.51 mL of a mixture of propylene glycol methyl ether acetate, α-terpineol and diethylene glycol (2:4:4 v/v) was mixed with 1.0 g of silver flakes (manufacturer specifications: flake size=5 to 8 μm; tap density=2.2 to 2.8 g/cm³; specific surface area=0.6 to 1.2 m²/g) and 0.15 g of silver oxide on a vortex mixer and bath sonicator to give a paste with 60.2 weight % silver, 9.0 weight % silver oxide, and solvent as the remainder. This formulation corresponded to silver at 16 volume % based on the total volume of the formulation. This formulation was dispensed onto native SiO₂/Si substrates. The paste was attached with a fluoropolymer-coated glass, then heated at a temperature ramping rate of 3° C. per minute from 60° C. to 160° C. with isothermal hold for 30 minutes, in nitrogen.

### Example 5f

0.28 mL of a mixture of propylene glycol methyl ether acetate, α-terpineol and diethylene glycol (3:5:2 v/v) was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 76.5 weight % silver, and solvent as the remainder. This formulation corresponded to silver at 26 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 3° C. per minute to 160° C. with isothermal hold for 30 minutes, in nitrogen.

### Summary of Examples

Example formulations according to the present application as described above illustrate the diversity of high-performance paste formulations that can be achieved to cover a wide variety of applications. Without further optimization, the dc electrical conductivities of the films from these formulations were already better than 1.0×10⁵ S/cm after sintering in nitrogen at a temperature of 200° C. or lower, often at 160° C., with corresponding thermal conductivities better than 75 W/mK. In numerous cases, dc electrical conductivities of the films were better than 1.2×10⁵ S/cm, with corresponding thermal conductivities better than 90 W/mK. In some cases, de electrical conductivities of the films are better than 1.4×10⁵ S/cm, with corresponding thermal conductivities better than 105 W/mK.

The lap shear strengths on untreated smooth native SiO₂ were typically better than 1 MPa. In some cases, they were better than 2 MPa.

In a typical test protocol, the silver pastes were formulated as indicated above, and coated by doctor blade onto Si wafers with native oxide to a wet thickness of 250 μm and area of 8×8 mm². A generic drying-and-sintering temperature-time profile was applied without optimization and without any applied pressure on the paste film. Typically, a pre-drying step at 60° C. for 20 minutes in air, attached with a fluoropolymer-coated glass to simulate the attachment of a second component (but removable for measuring conductivities), then heated at a temperature ramping rate of 7.5° C. per minute to 160° C. with isothermal hold for 15 minutes, in nitrogen. In some experiments, a single temperature ramping rate of 3° C. per minute to 200° C. with isothermal hold for 30 minutes was employed. The coated paste was partially enclosed by a cover slip to slow down solvent evaporation.

Both flake and spheroidal silver powders were tested. The ability to obtain high conductivities in pressureless sintering at or below 200° C. in an inert atmosphere even for spheroidal silver powders demonstrated the effectiveness and utility of the present pastes. The sintered spheroidal silver film, however, had no adhesion to the native SiO₂.

Heating was performed on a digital hotplate that was first calibrated with melting-point standards. Dc electrical conductivity was measured by four-point-probe method and corrected for film thickness and size. A high-accuracy microvoltmeter was used for measurement of the microvolt voltages. Film thicknesses were measured by profilometer or micrometer gauge. Thermal conductivities were estimated by Wiedemann-Franz law, in which the ratio of thermal conductivity to electrical conductivity is taken to be constant, as free electrons provide for both thermal and electrical transport in metals. Lap shear strength was measured in a home-built tool with double-sided tape attachment to bottom surface of Si die and top surface of sintered metal film. This limited reliable measurements to 2 MPa due to adhesive failure of mounting tape, but this was sufficient to demonstrate the adequate adhesion strength even on a demanding substrate like native SiO₂. The formulations sintered well to silver, gold, platinum and palladium surfaces.

In summary, the above examples had electrical conductivities of better than 1.0×10⁵ S/cm. The corresponding thermal conductivities were estimated to be better than 75 W/mK, based on Wiedemann-Franz law for silver powder composites. The adhesion strength on native SiO₂/Si surfaces for the flake formulations above was typically higher than 1 MPa. For comparison, without the modifier polymer and co-deoxidizer solvent, the adhesion strength was less than 0.1 MPa.

### Comparative Example 1—PELCO® Conductive Silver Paint

PELCO® conductive silver paint (Ted Pella Inc, product No. 16062) was used as received and applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen. This comparative example had an electrical conductivity 2×10⁴ S/cm.

### Comparative Example 2—Silver Flakes in Ethylene Glycol

Ethylene glycol is a solvent that is commonly used in the art. 0.22 mL of ethylene glycol was mixed with 1.0 g of silver flakes (manufacturer specifications: flake size=5 to 8 μm; tap density=2.2 to 2.8 g/cm3; specific surface area=0.6 to 1.2 m²/g) on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 90° C. for 15 minutes in air, attached with a fluoropolymer-coated glass, then heated at a temperature ramping rate of 7.5° C. per minute to 160° C. with isothermal hold for 30 minutes, in nitrogen. This comparative example had an electrical conductivity of 2×10⁴ S/cm.

### Comparative Example 3—Silver Flakes in α-Terpineol

0.22 mL of α-terpineol was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 100° C. for 15 minutes in air, attached with a fluoropolymer-coated glass, then heated at a temperature ramping rate of 7.5° C. per minute to 200° C. with isothermal hold for 30 minutes, in nitrogen. This comparative example had an electrical conductivity of 8×10⁴ S/cm.

### Comparative Example 4—Silver Flakes and Poly(Hydroxystyrene) in α-Terpineol

0.22 mL of 40% hydrolyzed poly(vinyl alcohol) dissolved in α-terpineol was mixed with 1.0 g of silver flakes (manufacturer specifications: flake size=5 to 8 μm; tap density=2.2 to 2.8 g/cm³; specific surface area=0.6 to 1.2 m²/g) on a vortex mixer and bath sonicator to give a paste with 81.9 weight % silver, 0.7 weight % polymer, and solvent as the remainder. This formulation corresponded to silver at 29 volume % based on the total volume of the formulation. This formulation was applied by doctor blading onto native SiO₂/Si substrates to a wet thickness of 250 μm and area of 8×8 mm². The paste was pre-dried at 100° C. for 15 minutes in air, attached with a fluoropolymer-coated glass, then heated at a temperature ramping rate of 7.5° C. per minute to 200° C. with isothermal hold for 30 minutes, in nitrogen. This comparative example had an electrical conductivity of 8×10⁴ S/cm.

### Comparative Example 5—Silver Flakes and Poly(vinyl pyrrolidone) in Propylene Glycol Methyl Ether Acetate

1.2 mL of poly(vinyl pyrrolidone) dissolved in ethylene glycol at a polymer concentration of 60 mg/mL was mixed with 3.0 g of silver flakes (manufacturer specifications: flake size=5 to 8 μm; tap density=2.2 to 2.8 g/cm³; specific surface area=0.6 to 1.2 m²/g) on a vortex mixer and bath sonicator, and left overnight. 12 mL of ethylene glycol was added and the silver flakes were isolated by centrifugation. The flakes were rinsed with 12 mL of Millipore® water, isolated by centrifugation, further rinsed with 12 mL of isopropanol, isolated by centrifugation, and finally vacuum dried. 0.22 mL of propylene glycol methyl ether acetate was mixed with 1.0 g of the pre-exchanged silver flakes on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen. This comparative example did not sinter.

### Comparative Example 6—Silver Flakes and Poly(2-hydroxyethylmethacrylate) in Diglyme

1.2 mL of poly(2-hydroxyethylmethacrylate) dissolved in ethylene glycol at a polymer concentration of 60 mg/mL was mixed with 3.0 g of silver flakes (manufacturer specifications: flake size=5 to 8 μm; tap density=2.2 to 2.8 g/cm³; specific surface area, 0.6 to 1.2 m²/g) on a vortex mixer and bath sonicator, and left overnight. 12 mL of ethylene glycol was added and the silver flakes were isolated by centrifugation. The flakes were rinsed with 12 mL of Millipore® water, isolated by centrifugation, further rinsed with 12 mL of isopropanol, isolated by centrifugation, and finally vacuum dried. 0.22 mL of diglyme was mixed with 1.0 g of the pre-exchanged silver flakes on a vortex mixer and bath sonicator to give a paste with 82.6 weight % silver, and solvent as the remainder. This formulation corresponded to silver at 30 volume % based on the total volume of the formulation. This formulation was applied by doctor blading onto native SiO₂/Si substrates to a wet thickness of 250 μm and area of 8×8 mm². The paste was pre-dried at 60° C. for 20 minutes in air, attached with a fluoropolymer-coated glass, then heated at a temperature ramping rate of 7.5° C. per minute to 160° C. with isothermal hold for 30 minutes, in nitrogen. This comparative example did not sinter.

### INDUSTRIAL APPLICABILITY

The composition and composite material of the disclosure may be used in a variety of applications such as electrical and thermal conductive materials, thermal interface, die attach, electrical interconnect and electrode materials.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1.-19. (canceled)

20. A composition comprising a deoxidizer solvent, a co-solvent and a plurality of silver particles suspended in a mixture of the deoxidizer solvent and the co-solvent,
wherein the deoxidizer solvent comprises one or more compounds of the formula CₙOₘH₂ₙ₊₂₋ₚ(OH)ₚ, where n, m and p are integers, with the proviso that 1≤(n+m)/p≤8, and
wherein the mixture of the deoxidizer solvent and the co-solvent comprises hydroxyl groups at a concentration in the range of 2 M to 20 M.

21. The composition of claim 20, wherein the deoxidizer solvent and the co-solvent have a combined weight percentage in the range of 6 weight % to 30 weight % based on the total weight of the composition.

22. The composition of claim 20, wherein the plurality of silver particles are in the form of flakes, granules, spheroids or a combination thereof.

23. The composition of claim 20, wherein the plurality of silver particles comprise elemental silver particles, silver alloy particles, silver-coated particles, silver oxide particles or a combination thereof.

24. The composition of claim 20, wherein the deoxidizer solvent has a boiling point in the range of 190° C. to 350° C.

25. The composition of claim 20, wherein the deoxidizer solvent is selected from the group consisting of ethylene glycol, diethylene glycol, triethylene glycol, tetraethylene glycol, dipropylene glycol, tripropylene glycol, isomers of propanediol, isomers of butanediol, isomers of pentanediol, isomers of hexanediol, isomers of heptanediol, isomers of octanediol, glycerol, pentaerythritol, dipentaerythritol, 2-(2-methoxyethoxy)ethanol, 2-(2-ethoxyethoxy)ethanol and a combination thereof.

26. The composition of claim 20, wherein the co-solvent has a boiling point in the range of 60° C. to 350° C.

27. The composition of claim 20, wherein the co-solvent comprises one or more polarizable groups selected from alkenyl groups, aromatic groups, carbonyl groups or ether groups.

28. The composition of claim 20, wherein the co-solvent is selected from the group consisting of xylene isomers, mesitylene, tetralin, terpinene, limonene, linalool, α-terpineol, geraniol, citronellol, diglyme, 1,2-dibutoxyethane, diethylene glycol butyl methyl ether, triethylene glycol dimethyl ether, diethylene glycol butyl ether, tripropylene glycol methyl ether, triethylene glycol ethyl ether, triethylene glycol butyl methyl ether, triethylene glycol butyl ether, propylene glycol methyl ether, sulfolane, 2-(2-butoxyethoxy)ethanol, phenoxyethanol, 2-(benzyloxy)ethanol, di(propylene glycol) methyl ether, 2-butoxyethanol acetate, ethylene glycol diacetate, propylene glycol methyl ether acetate, di(propylene glycol) methyl ether acetate, 2-(2-ethoxyethoxy)ethyl acetate, ethylene glycol monobutyl ether acetate, 2-ethoxyethyl acetate, ethylene glycol monoethyl ether acetate, 2-butoxyethyl acetate, ethanolamine, diethanolamine, Texanol™ ester alcohol, diethyl adipate, dimethyl succinate, methyl benzoate, N-methylpyrrolidone, γ-butyrolactone, diethyl carbonate, propylene carbonate, safrole, anethole, cyclohexanone, cyclohexanol, carvone, ethyl sorbate, pseudoionone, farnesene, 2,6-dimethyl-2,4,6,-octatriene, o-cresol, methyl salicylate and a combination thereof.

29. The composition of claim 20, further comprising a modifier polymer.

30. The composition of claim 20, further comprising a reducing metal.

31. A method of forming a composition comprising the step of dispersing a plurality of silver particles in a deoxidizer solvent in the presence of a co-solvent or in a mixture of the deoxidizer solvent and the co-solvent.

32. A method of forming a composite material, comprising the step of sintering a composition on a substrate, wherein the composition comprises a deoxidizer solvent, a co-solvent and a plurality of silver particles suspended in a mixture of the deoxidizer solvent and the co-solvent,
wherein the deoxidizer solvent comprises one or more compounds of the formula CₙOₘH₂ₙ₊₂₋ₚ(OH)ₚ, where n, m and p are integers, with the proviso that 1≤(n+m)/p≤8, and
wherein the mixture of the deoxidizer solvent and the co-solvent comprises hydroxyl groups at a concentration in the range of 2 M to 20 M.

33. The method of claim 32, wherein the sintering step is undertaken at a temperature in the range of 140° C. to 200° C.

34. The method of claim 32, wherein the sintering step is undertaken in an inert atmosphere.

35. The method of claim 32, further comprising a step of pre-drying the composition before the sintering step.

36. The method of claim 32, further comprising a step of contacting the composition with a second substrate or component before the sintering step.

37. The method of claim 36, wherein the one or more substrates are selected from the group consisting of electronic components and thermal components.
